(19) United States
(12) Patent Application Publication
(10) Pub. No.: US 2012/0081674 A1
(43) Pub. Date: Apr. 5, 2012

(54) LIGHT SOURCE APPARATUS AND PROJECTION DISPLAY APPARATUS

(75) Inventor: Michihiro Okuda, Hirakata-City (JP)

(73) Assignee: SANYO ELECTRIC CO., LTD., Osaka (JP)

(21) Appl. No.: 13/250,422

(22) Filed: Sep. 30, 2011

(30) Foreign Application Priority Data
Sep. 30, 2010 (JP) 2010-222420

(51) Int. Cl. G03B 21/14; F21V 9/14

(52) U.S. Cl. 353/20; 362/19

(57) ABSTRACT

A light source apparatus includes: a light source; a reflection rotary body; an optical path changing element; and a polarization controller. The polarization controller controls polarization of the first color component light to a different polarization by means of transmission of the first color component light emitted from the light source and by means of transmission of the first color component light reflected by the reflection rotary body. The optical path changing element guides the first color component light reflected by the reflection rotary body, in a direction different from a direction of the first color component light emitted from the light source, in accordance with the polarization of the first color component light modulated by the polarization controller.

### CROSS REFERENCE TO RELATED APPLICATIONS

This application is based upon and claims the benefit of priority from prior Japanese Patent Application No. 2010-222420, filed on Sep. 30, 2010; the entire contents of which are incorporated herein by reference.

### BACKGROUND OF THE INVENTION

1. Field of the Invention

The present invention relates to a light source apparatus and a projection display apparatus, including: a light source that emits first color component light employed as excitation light; and a luminous body that emits second color component light in accordance with the first color component light.

2. Description of the Related Art

Conventionally, there has been known a projection display apparatus having: a light source; an imager that modulates light emitted from the light source; and a projection unit that projects the light modulated by means of the imager, into a projection surface.

There has also been proposed a projection display apparatus having a light emitting member that emits fundamental image light such as red component light, green component light, or blue component light while the light emitted from a light source is employed as excitation light (for example, JP-A-2004-341105). Specifically, a plurality of types of luminous bodies that emits the respective color component light beams are arranged at a color wheel, and the respective color component light beams are emitted in time division by means of rotation of the color wheel.

Incidentally, light usage of a reflection color wheel is higher than light usage of a transmission color wheel. In a case where the reflection color wheel is employed, an optical path of blue component light (fundamental image light) to be reflected by the reflection color wheel needs to be different from that of blue component light (excitation light) to be guided to the reflection color wheel.

### SUMMARY OF THE INVENTION

A light source apparatus according to a first feature includes: a light source (light source 10B) that emits first color component light employed as excitation light; a reflection rotary body (color wheel 30) having a reflection body (reflection mirror 32B) that reflects the first color component light and a luminous body (luminous body 31R, 31G, for example) that emits second color component light in accordance with the first color component light; an optical path changing element (optical path changing element 20, for example) disposed between the light source and the reflection rotary body on an optical path of the first component light; and a polarization controller (polarization controller 40) disposed between the optical path changing element and the reflection rotary body on an optical path of the first component light. The polarization controller controls polarization of the first color component light to a different polarization by means of transmission of the first color component light emitted from the light source and by means of transmission of the first color component light reflected by the reflection body. The optical path changing element guides the first color component light reflected by the reflection body, in a direction different from a direction of the first color component light emitted from the light source, in accordance with the polarization of the first color component light modulated by the polarization controller.

In the first feature, the light source emits first color component light of P-polarization to the optical path changing element. The polarization controller controls first color component light of P-polarization to first color component light of S-polarization by means of transmission of the first color component light emitted from the light source and by means of transmission of the first color component light reflected by the reflection body. The optical path changing element transmits first color component light of P-polarization, and reflects first color component light of S-polarization.

In the first feature, the light source emits first color component light of S-polarization to the optical path changing element. The polarization controller controls first color component light of S-polarization to first color component light of P-polarization by means of transmission of the first color component light emitted from the light source and by means of transmission of the first color component light reflected by the reflection body. The optical path changing element reflects first color component light of S-polarization, and transmits first color component light of P-polarization.

In the first feature, the optical path changing element guides the second color component light emitted from the luminous body and the first color component light reflected by the reflection body, in a same direction.

In the first feature, the optical path changing element is a first optical path changing element. The light source apparatus includes a second optical path changing element (optical path changing element 120, for example) disposed between the light source and the first optical path changing element over an optical path of the first color component light. The second optical path changing element transmits the first color component light emitted from the light source, to a side of the first optical path changing element, and reflects the second color component light emitted from the luminous body.

A projection display apparatus according to a second feature includes: a light source that emits first color component light employed as excitation light; a reflection rotary body having a reflection body that reflects the first color component light and a luminous body that emits second color component light in accordance with the first color component light; an optical path changing element disposed between the light source and the reflection rotary body on an optical path of the first component light; a polarization controller disposed between the optical path changing element and the reflection rotary body on an optical path of the first component light; an imager that modulates the light guided by the optical path changing element; and a projection unit that projects the light modulated by the imager. The polarization controller controls polarization of the first color component light to a different polarization by means of transmission of the first color component light emitted from the light source and by means of transmission of the first color component light reflected by the reflection body. The optical path changing element guides the first color component light reflected by the reflection body, in a direction different from a direction of the first color component light emitted from the light source, in accordance with the polarization of the first color component light modulated by the polarization controller.

### BRIEF DESCRIPTION OF THE DRAWINGS

FIG. 1 is a view showing a projection display apparatus 100 according to a first embodiment.

FIG. 2 is a view showing characteristics of an optical path changing element 20 according to the first embodiment,

FIG. 3 is a view showing a color wheel 30 according to the first embodiment.

FIG. 4 is another view showing the color wheel 30 according to the first embodiment.

FIG. 5 is a view for explaining polarization modulation of blue component light B, according to the first embodiment.

FIG. 6 is a view showing a projection display apparatus 100 according to modification example 1.

FIG. 7 is a view showing characteristics of an optical path changing element 20A according to modification example 1.

FIG. 8 is a view showing a projection display apparatus 100 according to modification example 2.

FIG. 9 is a view showing characteristics of an optical path changing element 20B according to modification example 2.

FIG. 10 is a projection display apparatus 100 according to modification example 3.

FIG. 11 is a view showing characteristics of an optical path changing element 20C according to modification example 3.

FIG. 12 is a projection display apparatus 100 according to modification example 4.

### DETAILED DESCRIPTION OF THE EMBODIMENTS

Hereinafter, a light source apparatus and a projection display apparatus, according to embodiments of the present invention, will be described with reference to the drawings. In the following description of drawings, same or similar constituent elements are designated by same or similar reference numerals.

However, it should be noted that the drawings are merely schematically shown and ratios of each dimension differ from the actual ones. Therefore, the specific dimensions, etc., should be determined in consideration of the following description. Moreover, of course, constituent elements with their different dimensional interrelationships and ratios are included in the respective drawings as well.

### Overview of Embodiments

A light source apparatus according to the embodiments is provided with: a light source that emits first color component light employed as excitation light; a reflection rotary body having a reflection body that reflects the first color component light and a luminous body that emit second color component light in accordance with the first color component light; an optical path changing element disposed between the light source and the reflection rotating member over an optical path for the first color component light; and a polarization controller disposed between the optical path changing element and the reflection rotary body in the optical path for the first color component light. The polarization controller controls polarization of the first color component light to a different polarization by means of transmission of the first color component light emitted from the light source and by means of transmission of the first color component light reflected by a reflection body. The optical path changing element guides the first color component light reflected by the reflection body, in a direction different from that of the first color component light emitted from the light source, in accordance with polarization of the first color component light modulated by the polarization controller.

According to the embodiments, the polarization controller controls polarization of the first color component light to a different polarization by means of reciprocation of the first color component light. In this manner, the optical path changing element guides the first color component light reflected by the reflection body, in a direction different from that of the first color component light emitted from the light source. Therefore, in a case where the first color component light is employed as fundamental image light, it becomes possible to employ the reflection rotary body, enabling improvement of light usage.

The fundamental image light is light configuring an image, and is red component light, green component light, or blue component light, for example.

### First Embodiment

### (Projection Display Apparatus)

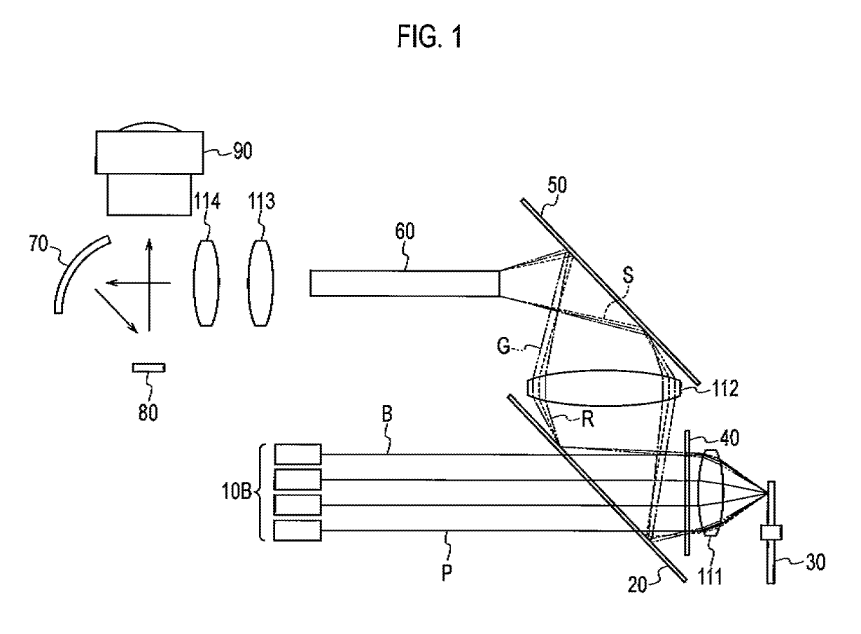

Hereinafter, a projection display apparatus according to a first embodiment will be described with reference to the drawings. FIG. 1 is a view showing a projection display apparatus 100 according to the first embodiment. The first embodiment illustrates a case in which red component light R, green component light G, and blue component light B are employed as fundamental image light.

First, as shown in FIG. 1, the projection display apparatus 100 has a light source 10B, an optical path changing element 20, a color wheel 30, a polarization controller 40, a reflection mirror 50, a rod integrator 60, a loopback mirror 70, a DMD 80, and a projection unit 90.

The light source 10B emits blue component light B with its high degree of polarization (P-polarization in the first embodiment). The blue component light B is employed as fundamental image light, and is also employed as excitation light of green component light G and red component light R. The light source 108 is an LD (Laser Diode) or an LED (Light Emitting Diode) and the like, for example.

The optical path changing element 20 is disposed between the light source 10B and the color wheel 30 over an optical path of the blue component light B (first color component light) emitted from the light source 10B. The optical path changing element 20 is a dichroic mirror, for example.

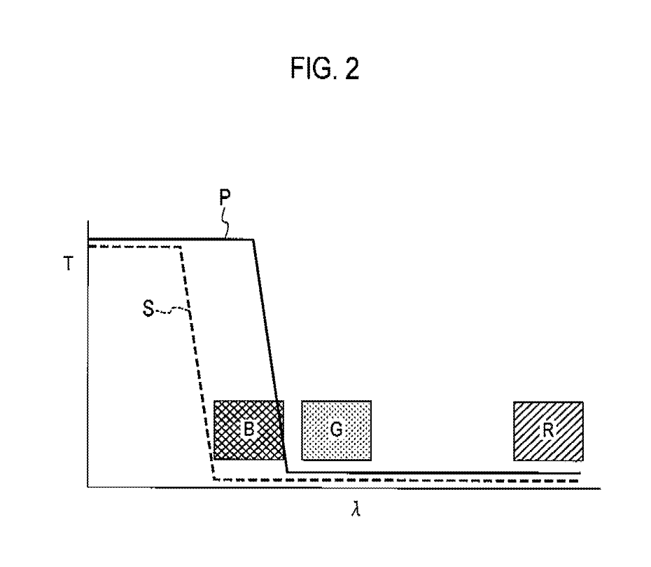

Specifically, the optical path changing element 20 has characteristics shown in FIG. 2. In FIG. 2, the vertical axis indicates a transmission rate, and the horizontal axis indicates a wavelength. As shown in FIG. 2, the optical path changing element 20 reflects green component light G and red component light R. In addition, the optical path changing element 20 transmits blue component light B of P-polarization and blue component light B of S-polarization.

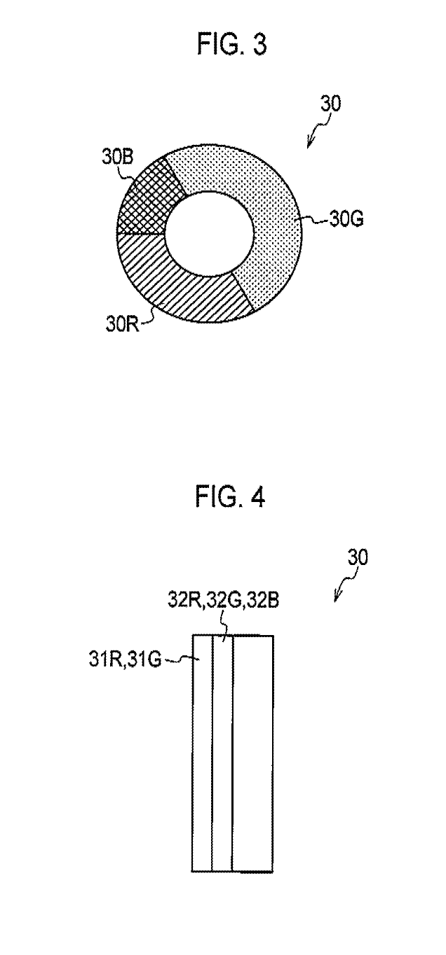

The color wheel 30 is that be rotatable, and has a red region 30R, a green region 30G, and a blue region 30B, as shown in FIG. 3.

The red region 30R, as shown in FIG. 4, has a luminous body 31R emitting red component light R (second color component light) in accordance with the blue component light B (first color component light) emitted from the light source 10B. The red region 30R has a reflection mirror 32R in a wheel surface distant from the light source 10B.

The luminous body 31R is a fluorescent body or a phosphor. The reflection mirror 32R reflects the red component light R emitted from the luminous body 31R, to the side of the optical change element 20. The mirror 32R may reflect the remaining component light of the blue component light B to the side of the luminous body 31R.

The green region 30G, as shown in FIG. 4, has a luminous body 31G emitting green component light G (second color component light) in accordance with the blue component light B (first color component light) emitted from the light source 10B, in a wheel surface proximal to the light source 10B. The green region 30G has a reflection mirror 32G in a wheel surface distant from the light source 10B.

The luminous body 31G is a fluorescent body or a phosphor. The reflection mirror 32G reflects the green component light G emitted from the luminous body 31G, to the side of the optical change element 20. The mirror 32G may reflect the remaining component light of the blue component light B to the side of the luminous body 31G.

The blue region 30B, as shown in FIG. 4, has a reflection mirror 32B that reflects the blue component light B (first color component light) emitted from the light source 10B. The reflection mirror 32B reflects the blue component light B to the side of the optical path changing element 20. Since the blue component light B is employed as fundamental image light, of course, the blue region 30B does not have a luminous body.

The polarization controller 40 is disposed between the optical path changing element 20 and the color wheel 30 over an optical path of the blue component light B (first color component light) emitted from the light source 10B. The polarization controller 40 controls polarization of the blue component light (first color component light) emitted from the light source 10B, to a different polarization, by means of transmission of the blue component light B (first color component light) emitted from the light source 10B and by means of transmission of the blue component light B (first color component light) reflected by the reflection mirror 32B.

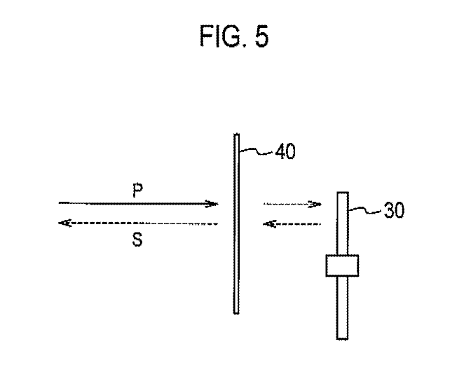

For example, the polarization controller 40 is a ¼λ plate. The polarization controller 40 controls a polarization direction of blue component light B from a linear polarization to a circular polarization. Alternatively, the polarization controller 40 controls a polarization direction of blue component light B from a circular polarization to a linear polarization. That is, as shown in FIG. 5, the polarization controller 40 controls the blue component light B (first color component light) of P-polarization relative to the optical path changing element 20 to the blue component light B (fundamental image light) of S-polarization relative to the optical path changing element 20 by means of reciprocation of the blue component light B.

Accordingly, in the first embodiment, the optical path changing element 20 described above guides the blue component light B (fundamental image light) of S-polarization, which is reflected by the reflection mirror 32B, in a direction different from that of the blue component light B of P-polarization (first color component light), which is emitted from the light source 10B, in accordance with polarization of the blue component light (first color component light) modulated by the polarization controller 40.

In detail, the optical path changing element 20 transmits the blue component light B (first color component light) of P-polarization, which is emitted from the light source 10B, to the side of the color wheel 30. The optical path changing element 20 reflects the blue component light B (fundamental image light) of S-polarization, which is reflected by the color wheel 30, together with the red component light R and the green component light G that are reflected by the color wheel 30, to the side of the reflection mirror 50.

The reflection mirror 50 reflects the red component light R and the green component light G that are reflected by the optical path changing element 20 to the side of the rod integrator 60. Similarly, the reflection mirror 50 reflects the blue component light B (first color component light) of S-polarization, which is reflected by the optical path changing element 20, to the side of the rod integrator 60.

The rod integrator 60 is a hollow rod, an inside wall of which is configured with a mirror surface. The rod integrator 60 equalizes light incident to the rod integrator 60. The rod integrator 60 may be a solid rod configured with a transparent member such as a glass.

The loopback mirror 70 reflects light emitted from the rod integrator 60, to the side of the DMD 80.

The DMD 80 is configured with a plurality of microscopic mirrors, and the plurality of microscopic mirrors are mobile. Each of the microscopic mirrors is basically equivalent to one pixel. The DMD 80 switches whether or not to reflect light onto the side of the projection unit 90, by changing an angle of each of the microscopic mirrors.

The projection unit 90 projects onto a projection surface the light (image light) reflected by the microscopic mirrors that are arranged at the DMD 80.

The projection display apparatus 100, as shown in FIG. 1, has a required group of lenses (a lens in to a lens 114). The lens 111 focuses light onto a wheel surface of the color wheel 30. The lens 112 focuses light onto a light incidence surface of the rod integrator 60. The lens 113 and the lens 114 are relay lenses.

### (Functions and Advantageous Effects)

According to the first embodiment, the polarization controller 40 controls polarization of the blue component light (first color component light) emitted from the light source 10B, to a different polarization, by means of reciprocation of the blue component light B (first color component light). In this manner, the optical path changing element 20 guides the blue component light B (fundamental image light) reflected by the reflection mirror 32B, in a direction different from that of the blue component light (first color component light) emitted from the light source 10B. Accordingly, in a case where blue component light B is employed as fundamental image light, it becomes possible to employ the color wheel 30 (reflection rotary body), enabling improvement of light usage.

### MODIFICATION EXAMPLE 1

Hereinafter, modification example 1 of the first embodiment will be described. Hereinafter, descriptive matters different from those of the first embodiment will be mainly described.

In the first embodiment, the light source 10B emits blue component light B (first color component light) of P-polarization. On the other hand, in modification example 1, the light source 10B emits blue component light B (first color component light) of S-polarization.

### (Projection Display Apparatus)

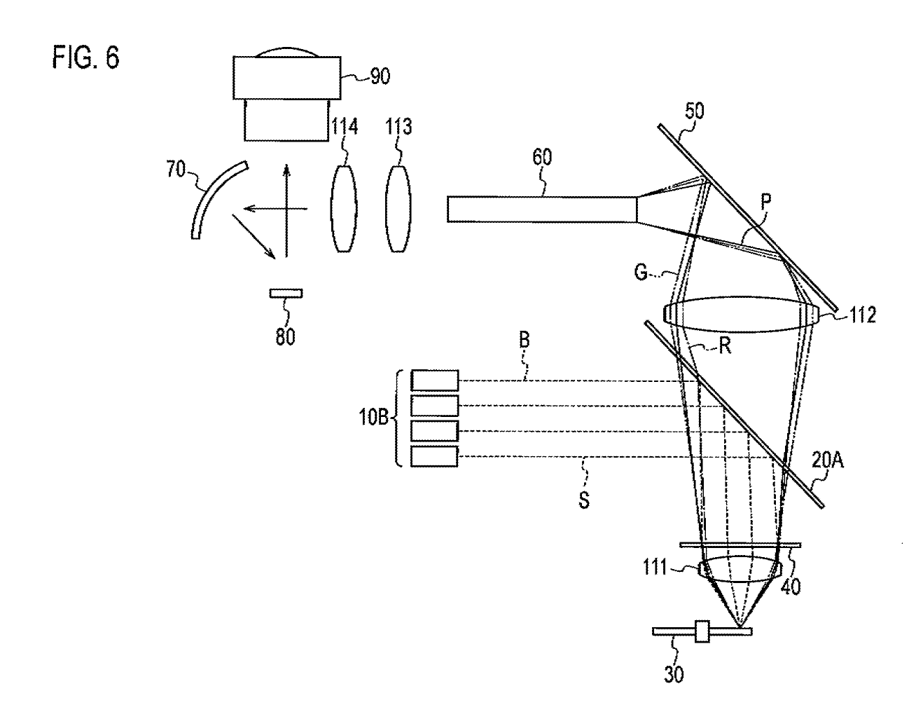

Hereinafter, a projection display apparatus according to modification example 1 will be described with reference to the drawings. FIG. 6 is a view showing a projection display apparatus 100 according to modification example 1. In FIG. 6, like constituent elements in FIG. 1 are designated by like reference numerals.

As shown in FIG. 6, the projection display apparatus 100 has an optical path changing element 20A in place of the optical path changing element 20. In addition, dispositions of the color wheel 30, the polarization controller 40, and the lens 111 are different.

The optical path changing element 20A is disposed between the light source 10B and the color wheel 30 over an optical path of the blue component light B (first color component light) emitted from the light source 10B. The optical path changing element 20A is a dichroic mirror, for example.

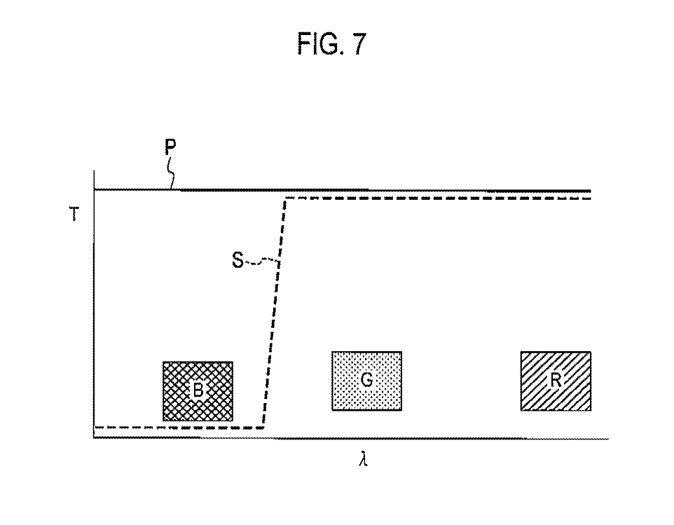

Specifically, the optical path changing element 20A has characteristics shown in FIG. 7. In FIG. 7, the vertical axis indicates a transmission rate, and the horizontal axis indicates a wavelength. As shown in FIG. 7, the optical path changing element 20A transmits green component light G and red component light R. In addition, the optical path changing element 20A transmits blue component light B of P-polarization, and reflects blue component light B of S-polarization.

In modification example 1, like the optical change element 20, the optical path changing element 20A guides the blue component light B (fundamental image light) of P-polarization, which is reflected by the reflection mirror 32B, in a direction different from that of the blue component light B (first color component light) of S-polarization, which is emitted from the light source 10B, in accordance with polarization of the blue component light B (first color component light) modulated by the polarization controller 40.

In detail, the optical path changing element 20A reflects the blue component light B (first color component light) of S-polarization, which is emitted from the light source 10B, to the side of the color wheel 30. The optical path changing element 20A transmits the blue component light B (fundamental image light) of P-polarization, which is reflected by the color wheel 30, together with red component light R and green component light G that are reflected by the color wheel 30, to the side of the reflection mirror 50.

### MODIFICATION EXAMPLE 2

Hereinafter, modification example 2 of the first embodiment will be described. Hereinafter, descriptive matters different from those of the first embodiment will be mainly described.

In the first embodiment, red component light R is emitted from the luminous body 31R in accordance with blue component light B (first color component light). On the other hand, in modification example 2, apart from the light source 10B, a light source emitting red component light R is arranged.

### (Projection Display Apparatus)

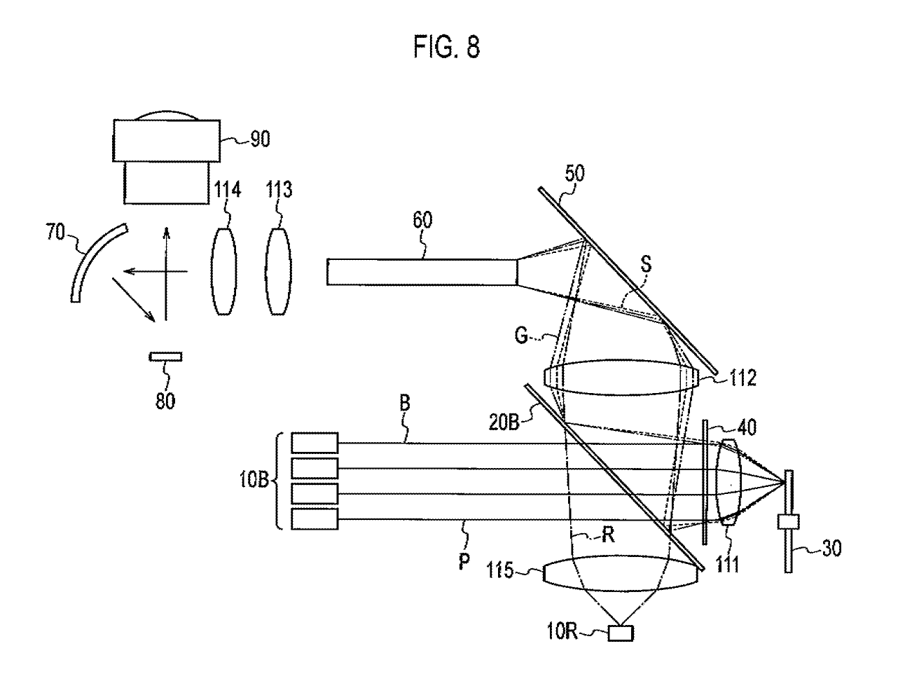

Hereinafter, a projection display apparatus according to modification example 2 will be described with reference to the drawings. FIG. 8 is a view showing a projection display apparatus 100 according to modification example 2. In FIG. 8, like constituent elements in FIG. 1 are designated by like reference numerals.

As shown in FIG. 8, the projection display apparatus 100 has a light source 10R in place of the light source 10B. In addition, the projection display apparatus 100 has an optical path changing element 20B in place of the optical path changing element 20.

Of course, the color wheel 30 does not have a red region 30R (luminous body 31R). In addition, a lens 115 parallelizes the red component light R emitted from the light source 10R is added.

The light source 10R emits red component light R as fundamental image light. The light source 10R is an LD (Laser Diode) or an LED (Light Emitting Diode), for example.

The optical path changing element 20B is disposed between the light source 10B and the color wheel 30 over an optical path of the blue component light B (first color component light) emitted from the light source 10B. The optical path changing element 20B is a dichroic mirror, for example.

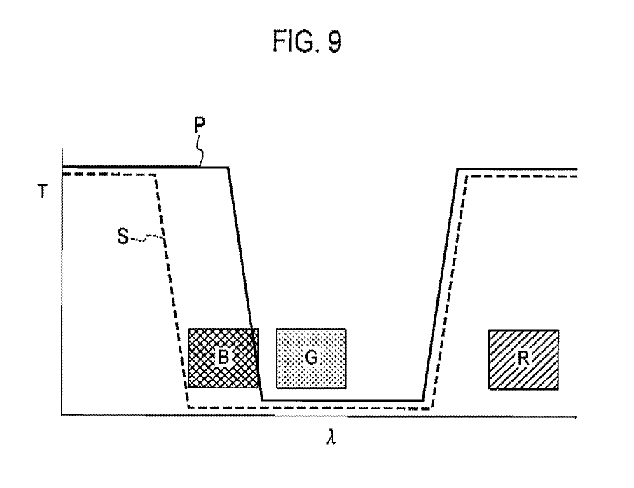

Specifically, the optical path changing element 20B has characteristics shown in FIG. 9. In FIG. 9, the vertical axis indicates a transmission rate, and the horizontal axis indicates a wavelength. As shown in FIG. 9, the optical path changing element 20B reflects green component light G, and transmits red component light R. In addition, the optical path changing element 20B transmits blue component light B of P-polarization, and reflects blue component light B of S-polarization. In modification example 2, like the optical path changing element 20, the optical path changing element 20B guides the blue component light B (first color component light) of S-polarization, which is reflected by the reflection mirror 32B, in a direction different from that of the blue component light B (first color component light) of P-polarization, which is emitted from the light source 10B, in accordance with polarization of the blue component light B (first color component light) modulated by the polarization controller 40.

In detail, the optical path changing element 20B transmits the blue component light B (first color component light) of P-polarization, which is emitted from the light source 10B, to the side of the color wheel 30. The optical path changing element 20B reflects the blue component light B (fundamental image light) of S-polarization, which is reflected by the color wheel 30, together with the green component light G reflected by the color wheel 30 and the red component light R emitted from the light source 10R, to the side of the reflection mirror 50.

### MODIFICATION EXAMPLE 3

Hereinafter, modification example 3 of the first embodiment will be described. Hereinafter, descriptive matters different from those of the first embodiment will be mainly described.

In the first embodiment, an optical path of blue component light B employed as fundamental image light completely superposes optical paths of red component light R and green component light G that are employed as fundamental image light beams on each other. On the other hand, in modification example 3, an optical path of blue component light B employed as fundamental image light is superposed again after separated from optical paths of red component light R and green component light G that are employed as fundamental image light beams.

### (Projection Display Apparatus)

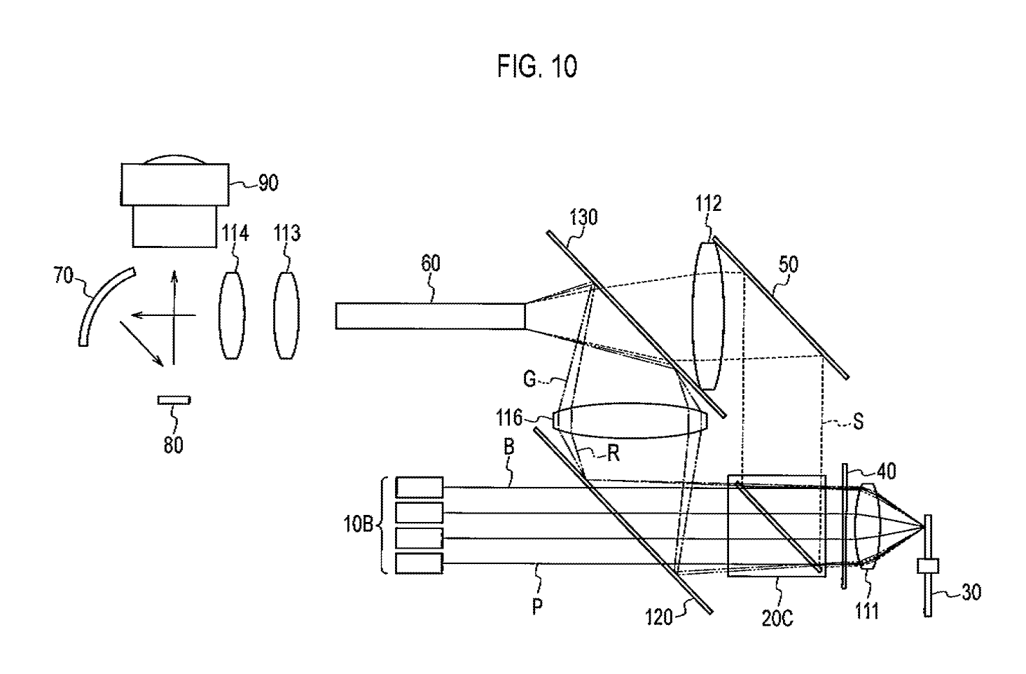

Hereinafter, a projection display apparatus according to modification example 3 will be described with reference to the drawings. FIG. 10 is a view showing a projection display apparatus 100 according to modification example 3. In FIG. 10, like constituent elements in FIG. 1 are designated by like reference numerals.

As shown in FIG. 10, the projection display apparatus 100 has an optical path changing element 20C in place of the optical path changing element 20. In addition, the projection display apparatus 100 has an optical path changing element 120 and an optical path changing element 130. A lens 116 focuses red component light R and green component light G is added to a light incidence surface of the rod integrator 60.

The optical path changing element 20C is disposed between the light source 10B and the color wheel 30 over an optical path of blue component light B (first color component light) emitted from the light source 10B. The optical path changing element 20C is a PBS cube, for example.

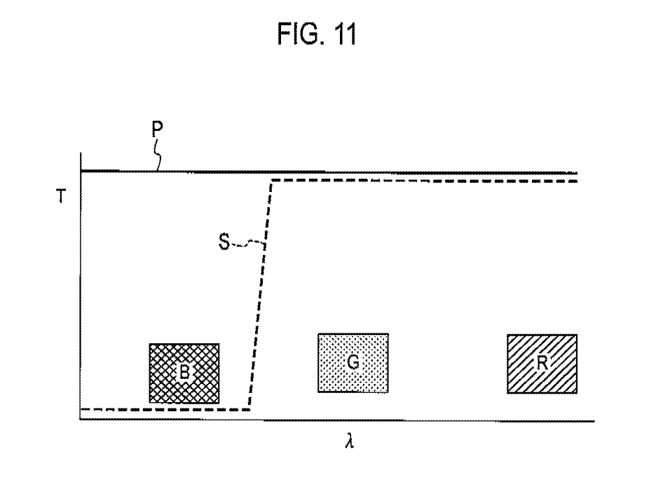

Specifically, the optical path changing element 20C has characteristics shown in FIG. 11. In FIG. 11, the vertical axis indicates a transmission rate, and the horizontal axis indicates a wavelength. As shown in FIG. 11., the optical path changing element 200 transmits red component light R and green component light G. In addition, the optical path changing element 20C transmits blue component light B of P-polarization, and reflects blue component light B of S-polarization.

In modification example 3, like the optical path changing element 20, the optical path changing element 20C guides the blue component light B (fundamental image light) of S-polarization, which is reflected by the reflection mirror 32B, in a direction different from that of the blue component light B (first color component light) of P-polarization, which is emitted from the light source 10B, in accordance with polarization of the blue component light B (first color component light) modulated by the polarization controller 40.

In detail, the optical path changing element 20C transmits the blue component light B (first color component light) of P-polarization, which is emitted from the light source 10B, to the side of the color wheel 30. The optical path changing element 20C transmits red component light R and green component light G that are reflected by the color wheel 30, to the side of the optical path changing element 120. The optical path changing element 20C reflects the blue component light B (fundamental image light) reflected by the color wheel 30, to the side of the reflection mirror 50.

In this manner, the optical path changing element 20C separates an optical path of blue component light B employed as fundamental image light, from optical paths of red component light R and green component light G that are employed as fundamental image light beams.

The optical path changing element 120 is disposed between the light source 10B and the optical path changing element 20C over an optical path of the blue component light B (first color component light) emitted from the light source 10B. The optical path changing element 120 is a dichroic mirror, for example.

The optical path changing element 120 transmits the blue component light B (first color component light) emitted from the light source 10B, to the side of the optical path changing element 20C (color wheel 30). In addition, the optical path changing element 120 reflects red component light R and green component light G that transmit the optical path changing element 20C (red component light R and green component light G that are reflected by the color wheel 30), to the side of the optical path changing element 130.

The optical path changing element 130 transmits blue component light B (fundamental image light) reflected by the reflection mirror 50, to the side of the rod integrator 60. The optical path changing element 130 reflects red component light R and green component light G (fundamental image light beams) that are reflected by the optical path changing element 120, to the side of the rod integrator 60. The optical path changing element 130 is a dichroic mirror, for example.

### MODIFICATION EXAMPLE 4

Hereinafter, modification example 4 of the first embodiment will be described. Hereinafter, matters different from those of modification example 3 will be mainly described.

In modification example 3, red component light R is emitted from the luminous body 31R in accordance with blue component light (first color component light). On the other hand, in modification example 4, apart from the light source 10B, a light source emitting red component light R is arranged.

### (Projection Display Apparatus)

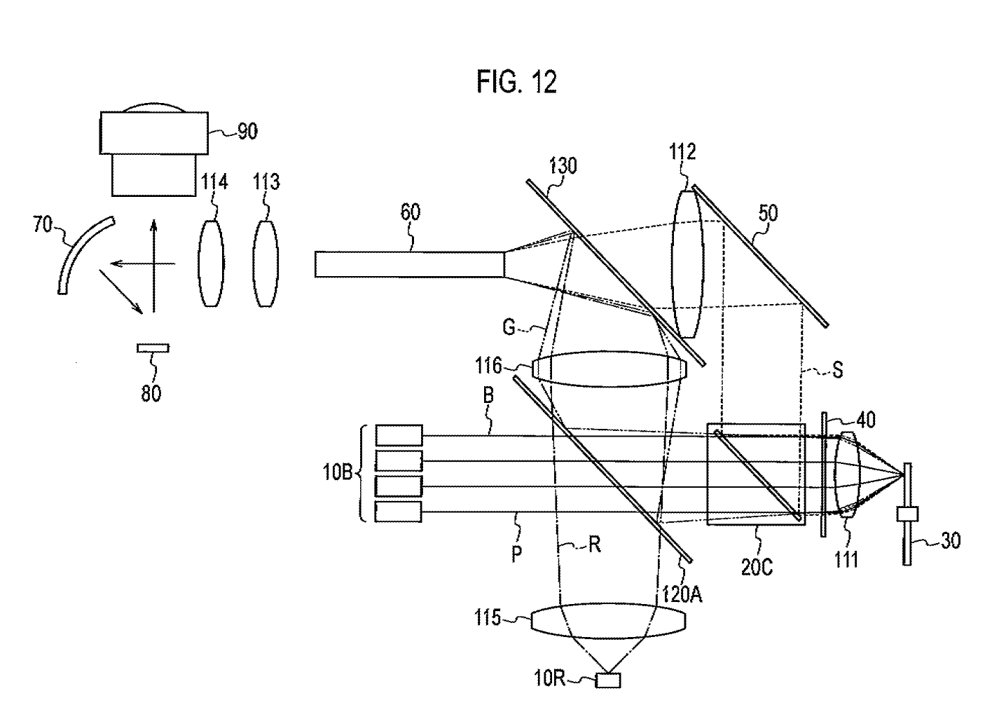

Hereinafter, a projection display apparatus according to modification example 4 will be described with reference to the drawings. FIG. 12 is a view showing a projection display apparatus 100 according to modification example 4. In FIG. 12, like constituent elements in FIG. 1 are designated by like reference numerals.

As shown in FIG. 12, the projection display apparatus 100 has a light source 10R in place of the light source 10B. In addition, the projection display apparatus 100 has an optical path changing element 120A in place of the optical path changing element 120.

Of course, the color wheel 30 does not have a red region 30R (luminous body 31R). In addition, a lens 115 parallelizes red component light R emitted from the light source 10R is added.

The optical path changing element 120A is disposed between the light source 10B and the optical path changing element 20C over an optical path of blue component light B (first color component light) emitted from the light source 10B. The optical path changing element 120A is a dichroic mirror, for example.

The optical path changing element 120A transmits the blue component light B (first color component light) emitted from the light source 10B, to the side of the optical path changing element 20C (color wheel 30). In addition, the optical path changing element 120A transmits the red component light R emitted from the light source 10R, to the side of the optical path changing element 130, and reflects green component light G (the red component light R and green component light G that are reflected by the color wheel 30) to the side of the optical path changing element 130.

### Other Embodiments

While the present invention has been described by way of the foregoing embodiments, it should not be understood that the discussion and drawings forming a part of this disclosure limit the invention. From this disclosure, a variety of substitute embodiments, examples, and operational technique would have been self-evident to one skilled in the art.

While the foregoing embodiments have illustrated a DMD 80 as an imager, the embodiments are not limitative thereto. The imager may be one liquid crystal panel or three liquid crystal panels (a red liquid crystal panel, a green liquid crystal panel, and a blue liquid crystal panel). The liquid crystal panel used herein may be a transmission liquid crystal panel or a reflection liquid crystal panel.

In the forgoing embodiments, a light source 10B emits blue component light B with its high degree of polarization. However, the embodiments are not limitative thereto. For example, as long as a polarization conversion element equalizes a polarization state to one polarization (P-polarization or S-polarization) is arranged on a light emission side of the light source 10B, the degree of polarization of the blue component light B emitted from the light source 10B may be low.

The foregoing embodiments have described a color wheel 30 as one example of reflection rotary body. However, the embodiments are not limitative thereto. The reflection rotary body used herein may be a rotating drum having a reflection body and a luminous body.

What is claimed is:

1. A light source apparatus comprising:
a light source that emits first color component light employed as excitation light;
a reflection rotary body having a reflection body that reflects the first color component light and a luminous body that emits second color component light in accordance with the first color component light;
an optical path changing element disposed between the light source and the reflection rotary body on an optical path of the first component light; and
a polarization controller disposed between the optical path changing element and the reflection rotary body on an optical path of the first component light, wherein
the polarization controller controls polarization of the first color component light to a different polarization by means of transmission of the first color component light emitted from the light source and by means of transmission of the first color component light reflected by the reflection body, and
the optical path changing element guides the first color component light reflected by the reflection body, in a direction different from a direction of the first color component light emitted from the light source, in accordance with the polarization of the first color component light modulated by the polarization controller.

2. The light source apparatus according to claim 1, wherein
the light source emits first color component light of P-polarization to the optical path changing element,
the polarization controller controls first color component light of P-polarization to first color component light of S-polarization by means of transmission of the first color component light emitted from the light source and by means of transmission of the first color component light reflected by the reflection body, and
the optical path changing element transmits first color component light of P-polarization, and reflects first color component light of S-polarization.

3. The light source apparatus according to claim 1, wherein
the light source emits first color component light of S-polarization to the optical path changing element,
the polarization controller controls first color component light of S-polarization to first color component light of P-polarization by means of transmission of the first color component light emitted from the light source and by means of transmission of the first color component light reflected by the reflection body, and
the optical path changing element reflects first color component light of S-polarization, and transmits first color component light of P-polarization.

4. The light source apparatus according to claim 1, wherein
the optical path changing element guides the second color component light emitted from the luminous body and the first color component light reflected by the reflection body, in a same direction.

5. The light source apparatus according to claim 1, wherein
the optical path changing element is a first optical path changing element, and comprises a second optical path changing element disposed between the light source and the first optical path changing element over an optical path of the first color component light, and
the second optical path changing element transmits the first color component light emitted from the light source, to a side of the first optical path changing element, and reflects the second color component light emitted from the luminous body.

6. A projection display apparatus comprising:
a light source that emits first color component light employed as excitation light;
a reflection rotary body having a reflection body that reflects the first color component light and a luminous body that emits second color component light in accordance with the first color component light;
an optical path changing element disposed between the light source and the reflection rotary body on an optical path of the first component light;
a polarization controller disposed between the optical path changing element and the reflection rotary body on an optical path of the first component light;
an imager that modulates the light guided by the optical path changing element; and
a projection unit that projects the light modulated by the imager, wherein
the polarization controller controls polarization of the first color component light to a different polarization by means of transmission of the first color component light emitted from the light source and by means of transmission of the first color component light reflected by the reflection body, and
the optical path changing element guides the first color component light reflected by the reflection body, in a direction different from a direction of the first color component light emitted from the light source, in accordance with the polarization of the first color component light modulated by the polarization controller.
